(19) United States
(12) Patent Application Publication
(10) Pub. No.: US 2013/0189637 A1
(43) Pub. Date: Jul. 25, 2013

(54) COMBINED GRAPHITE TUBE AND GRAPHITE CRUCIBLE CONSTITUTED THEREBY

(71) Applicant: SUN POWER SILICON CO., LTD., TAIPEI CITY (TW)

(72) Inventor: WEN-PIN SUN, Taichung City (TW)

(73) Assignee: SUN POWER SILICON CO., LTD., TAIPEI CITY (TW)

(21) Appl. No.: 13/741,383

(22) Filed: Jan. 15, 2013

(30) Foreign Application Priority Data
Jan. 20, 2012 (TW) 101201460

(51) Int. Cl. F27B 14/10

(52) U.S. Cl. CPC F27B 14/10
USPC 432/265; 156/296; 428/367

(57) ABSTRACT

A combined graphite tube is combined by stacking a plurality of graphite short-tubes together, where each graphite short-tube includes a upper coupling portion and a lower coupling portion, the upper coupling portion is positioned on a top face of a upper side of the graphite short-tube; and the lower coupling portion is positioned on a bottom face of a lower side of the graphite short-tube, and corresponds to the upper coupling portion, allowing the upper coupling portion of each graphite short-tube to be propped against the lower coupling portion of another graphite short-tube; the graphite short-tubes are fused and coupled together by means of a sintering treatment after the graphite short-tubes are stacked together. Whereby, the combined graphite tube of the present invention may be utilized in silicon smelting, and may be coupled to an enough length of graphite tube depending on requirements or derive a graphite crucible, capable of improving silicon smelting efficiency.

### (a) TECHNICAL FIELD OF THE INVENTION

The present invention relates to a graphite tube and a graphite crucible constituted by it, and particularly to equipment used for polysilicon smelting.

### (b) DESCRIPTION OF THE PRIOR ART

Taiwan Patent application No. 100138537(application date: Oct. 24, 2011) proposed by the applicant of the present invention discloses a technology and apparatus for refining solar-grade polysilicon by means of vacuum circulation, combining a RH(Rubrstahl/Heracus) furnace with VD (vacuum degassing) furnace to from an apparatus for refining solar-grade polysilicon by means of simplex-nozzle double vacuum circulation, and utilizing the vacuum stirring, diffusion and deoxidation of this apparatus to prepare solar-grade polysilicon. The apparatus for refining solar-grade polysilicon by means of simplex-nozzle double vacuum circulation includes a high vacuum room of the RH furnace at the upper side and a low vacuum room of the VD furnace (or combined intermediate frequency furnace) at the lower side, which is connected to each other through a simplex nozzle communication tube (round tube suction nozzle).

RH furnace is also referred to as cyclic vacuum furnace, developed jointly by two German companies, Rubrstahl and Heracus. The main operation method thereof is driving steel fluid to rise to a definite height after evacuation by inserting two conduits disposed on the lower side of a vacuum room into steel fluid, and then blowing in inert gas Ar via a riser tube to drive the steel fluid to enter the vacuum room for the acceptance of a vacuum treatment, and thereafter flowing it back to a ladle via another descending conduit. This method has become the main vacuum treatment method of steel fluid in advanced steel factories. However, lined nozzles in conduits used in steelmaking mostly are made of alumina, quartz (silicon oxide), ceramic, or other refractory material containing magnesium or boron. But, these materials are not suitable to be adopted as nozzles used in solar-grade polysilicon refining cyclic vacuum equipment (RH furnace).

### SUMMARY OF THE INVENTION

One object of the present invention is to provide a graphite tube, which is formed by graphite but without alumina, quartz (silicon oxide), ceramic, or other material containing magnesium or boron, such that no other reaction will be generated during metal silicon smelting.

To achieve the above object, a combined graphite tube is constituted by a plurality of graphite short-tubes stacked together, where each graphite short-tube includes a upper coupling portion and lower coupling portion, where the upper coupling portion is positioned on the top face of the upper side of the graphite short-tube, and lower coupling portion is positioned on the bottom face of the lower side of the graphite short-tube and corresponds to the upper coupling portion, allowing the upper coupling portion of each graphite short-tube to be propped against the lower coupling portion of another graphite short-tube, and each graphite short-tube to be fused with and coupled closely to another graphite short-tube by means of sintering treatment after each two graphite short-tubes are stacked together.

Whereby, the combined graphite tube of the present invention can be utilized in a silicon smelting operation, and a sufficient length of graphite tube can be coupled depending on a requirement, capable of improving the efficiency of silicon smelting operation.

Furthermore, the present invention allows the upper coupling portion to be a flat plane and the lower coupling portion to be a corresponding flat plane, the upper coupling portion to be an inclined plane inclined from outside to inside and the lower coupling portion to be an inclined plane inclined from inside to outside, or the upper coupling portion to be an inclined plane inclined from inside to outside and the lower coupling portion to be an inclined plane inclined from outside to inside. Otherwise, the present invention allows the upper coupling portion to be a bump and the upper coupling portion to be a corresponding recess, or the upper coupling portion to be a recess and the lower coupling portion to be a corresponding bump, thereby improving installment convenience.

In addition, the bump has an inclined face or a curved face, thereby facilitating the coupling and alignment of each two adjacent graphite short-tubes.

Furthermore, the present invention may allow the distance between the upper coupling portion of each graphite short-tube and the lower coupling portion of another graphite short-tube is smaller than 5 mm, benefiting carrying out sintering.

Furthermore, the present invention may allow pitch, tar, carbon glue, carbon paste, carbon and water (carbon mud), carbon dust, silicone, silicon paste, silicon water (mud) of silicon (Si), pozzolan or water is added in between each two adjacent graphite short-tubes, thereby facilitating the binding of each two adjacent graphite short-tubes.

Furthermore, the present invention further provide a graphite crucible constituted by the combined graphite tube, including the above graphite tube and a graphite base, where the graphite base includes a bottom coupling portion corresponding to the lower coupling portion, allowing the combined graphite tube to be stacked on the graphite base, and the raphite short-tubes and the graphite base to be fused and coupled closely together by means of a sintering treatment after all the graphite short-tubes and the graphite base are stacked together.

Whereby, the present invention may provide a crucible suitable for use in metal silicon smelting, suitable for used as a high-density graphite crucible used for a lining of a hot forge (including intermediate frequency furnace, arc furnace, VD furnace) suitable for use in metal silicon smelting, silicon ladling steel drum (silicon ladle), hot forge (including intermediate frequency furnace, arc furnace, VD furnace) doped with solar-grade polysilicon, RH furnace for refining solar-grade polysilicon by means of vacuum cyclic, solar-grade polysilicon refinery furnace, ingot furnace, or polycrystalline Furnace; the graphite crucibles used originally in these furnaces are smaller in size, causing the current limited productivity. Therefore, large high-density graphite crucibles can be manufactured through the present invention, thereby improving the productivity and solving a upstream industry chain of Photovoltaics.

### BRIEF DESCRIPTION OF THE DRAWINGS

FIG. 1 is a cross sectional view of a combined graphite tube of a preferred embodiment according to the present invention;

FIG. 2 is a partly enlarged view of FIG. 1;

FIG. 3 is a cross sectional view of a graphite crucible of a preferred embodiment according to the present invention;

FIG. 4 is a partly enlarged view of FIG. 3;

FIG. 5 is a cross sectional view of a graphite crucible of another preferred embodiment according to the present invention; and

FIGS. 6 to 16 are cross sectional views of various combination modes of combined graphite tube of other embodiments of the present invention.

### DETAILED DESCRIPTION OF THE PREFERRED EMBODIMENTS

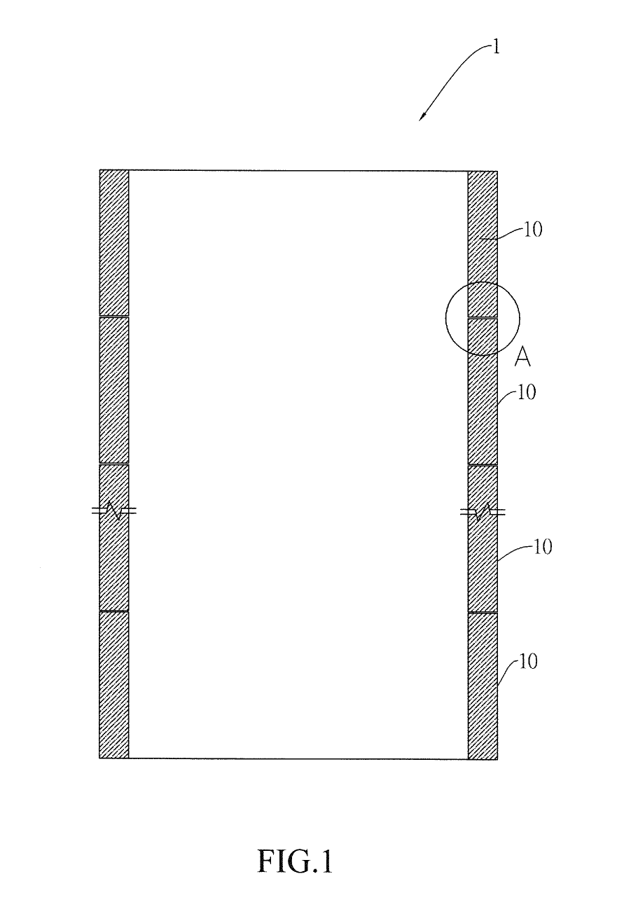

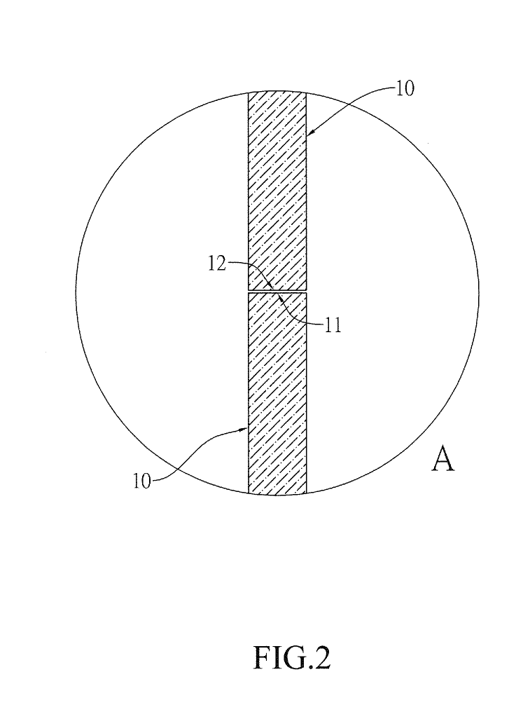

Referring to FIG. 1, illustrating a cross sectional view of a combined graphite tube 1 of a preferred embodiment of the present invention, and FIG. 2, illustrating a partly enlarged view of FIG. 1, the combined graphite tube 1 is constituted by stacking a plurality of graphite short-tubes 10 together, where each graphite short-tube 10 includes a upper coupling portion 11 and a lower coupling portion 12, where the upper coupling portion 11 is positioned on the top face of the upper side of the graphite short-tube 10, and the lower coupling portion 12 on the bottom face of the lower side of the graphite short-tube 10 and corresponds to the upper coupling portion 11, allowing the upper coupling portion 11 of each graphite short-tube 10 to be propped against the lower coupling portion 12 of the another graphite short-tube 10, and the two adjacent graphite short-tubes 10 to be fused and coupled closely together by means of a sintering treatment after the graphite short-tubes 10 are stacked together.

The graphite short-tube 10 of the present embodiment is formed of a core removing graphite body, no alumina, quartz (silicon oxide), ceramic, or other refractory material containing magnesium or boron exists therein such that no other reaction will be produced during metal silicon smelting, suitable for une in the conveying or loading of silicon material during silicon smelting. Furthermore, a plurality of graphite short-tubes may be coupled to a needed length, and sintering is then carried out, capable of being manufactured by matching every kind of use dimension requirement, where the proper temperature of the sintering treatment mentioned above is ranged approximately between 1000° C. and 2000° C.

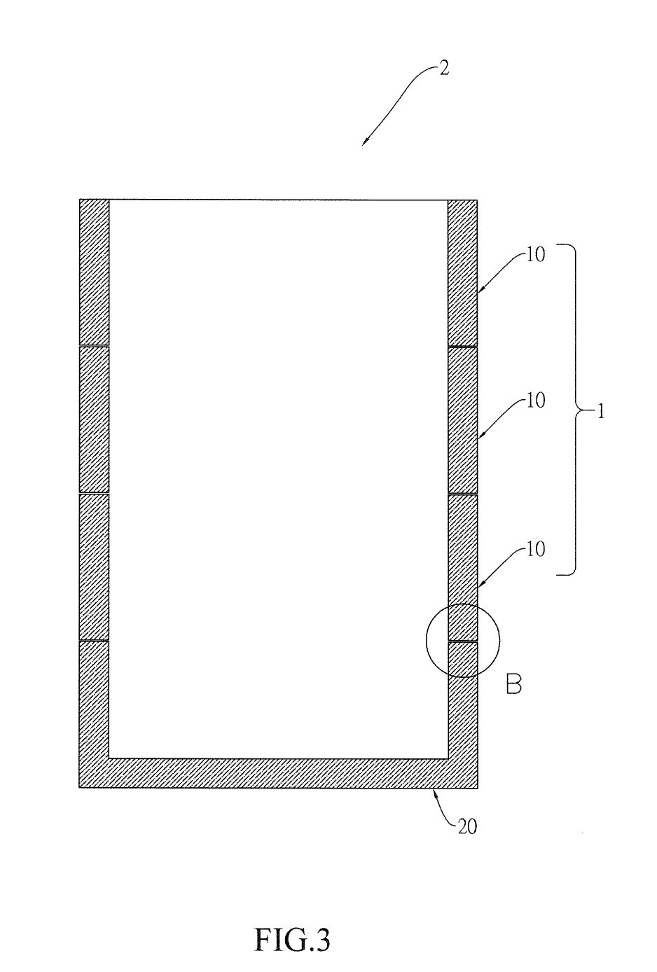

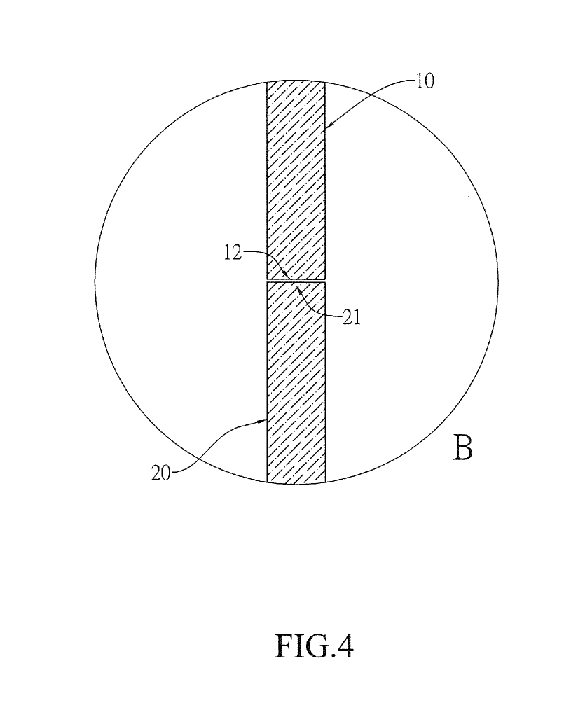

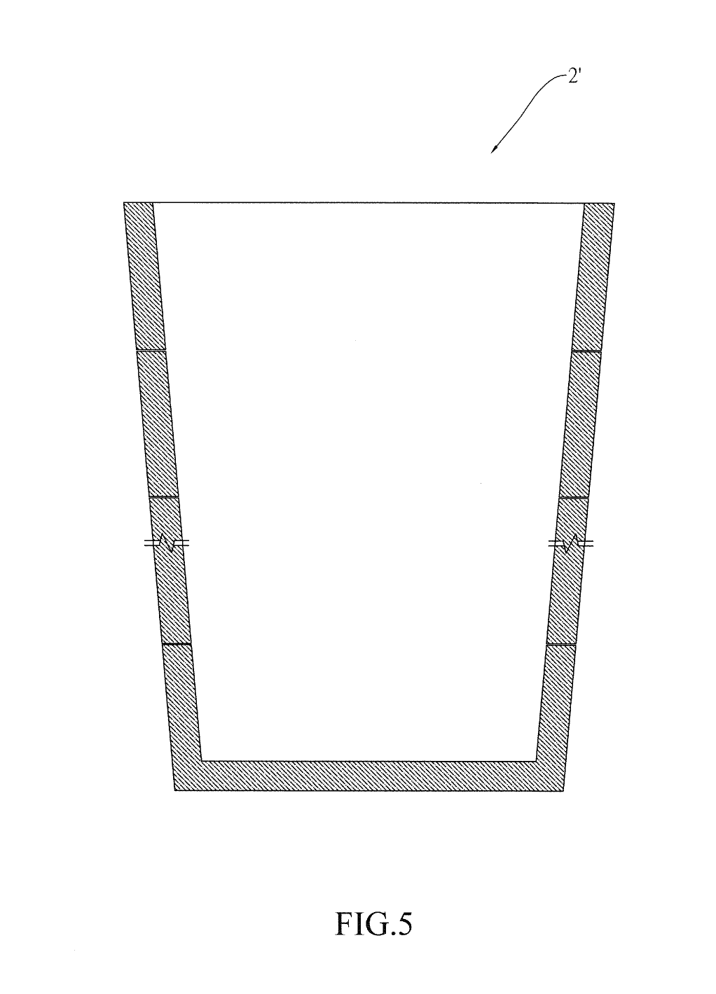

Furthermore, referring to FIGS. 3 and 4, illustrating respectively a cross section view and a partly enlarged view of a graphite crucible 2, the graphite crucible 2 includes the combined graphite tube 1 mentioned above and a graphite base 20 coupled to each other, where the graphite base 20 includes a bottom coupling portion 21 corresponding to the lower coupling portion 12, allowing the combined graphite tube 1 to be stacked on the graphite base 20. The graphite short-tubes 10 and the graphite base 20 are fused and coupled closely together by means of a sintering treatment after every graphite short-tube 10 and the graphite base 20 are stacked together, thereby forming the graphite crucible 2, capable of mounting fluid silicon for heating, and furthermore, facilitating the manufacturing of large-size crucibles. Therefore, the present embodiment is characterized in that tedious buckling structures (such as the configuration of screws for engagement) are not needed according to the present invention, and all graphite short-tubes 10 or the graphite short-tube and the graphite base 20 can then be allowed to prop against and couple to each other, such that the production speed can be increased and the stability improved.

In addition, the present invention may utilize different graphite short-tubes 10 to carry the combination, thereby to form needed profiles. For example, in an exemplary embodiment, another graphite crucible 2′ is formed to be a body with an opening is larger than the graphite base 20 in area (close to a taper).

Because the bottom coupling portion 21 on the graphite base 20 is used to prop against the corresponding lower coupling portion 12; it may be the same structure as the upper coupling portion 11. Furthermore, because there are many combination ways, the following will describe various practicable combination patterns of the upper coupling portion 11 and lower coupling portion 12 with respect to accompanying drawings.

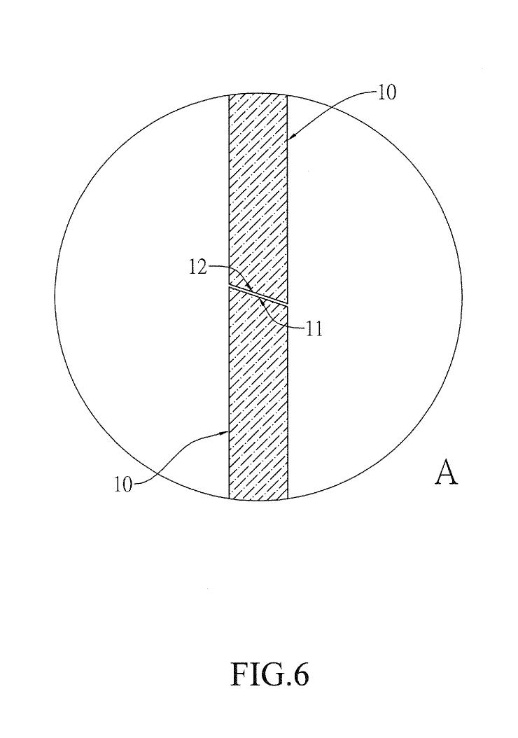

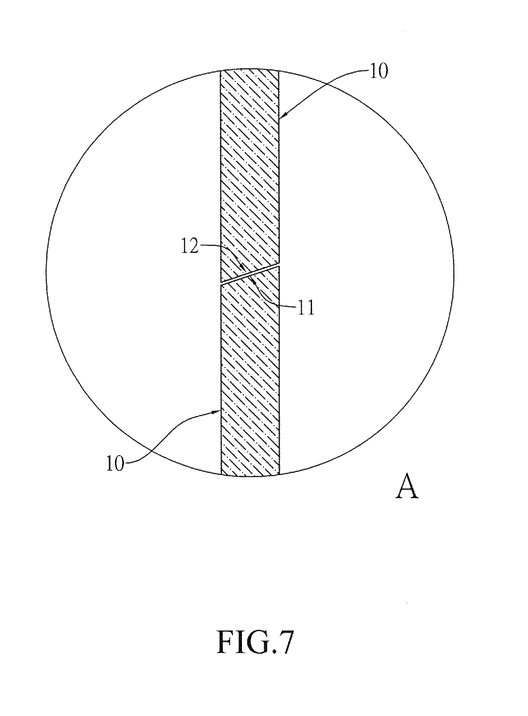

Referring to FIG. 2, the upper coupling portion 11 is planar and the lower coupling portion 12 should be planar, the upper coupling portion 11 is an inclined plane inclined upward from outside to inside and the lower coupling portion 12 is an inclined plane inclined upward from outside to inside as FIG. 6 shows. Otherwise, the upper coupling portion 11 is an inclined plane inclined upward from inside to outside and the lower coupling portion 12 is an inclined plane inclined upward from inside to outside as FIG. 7 shows.

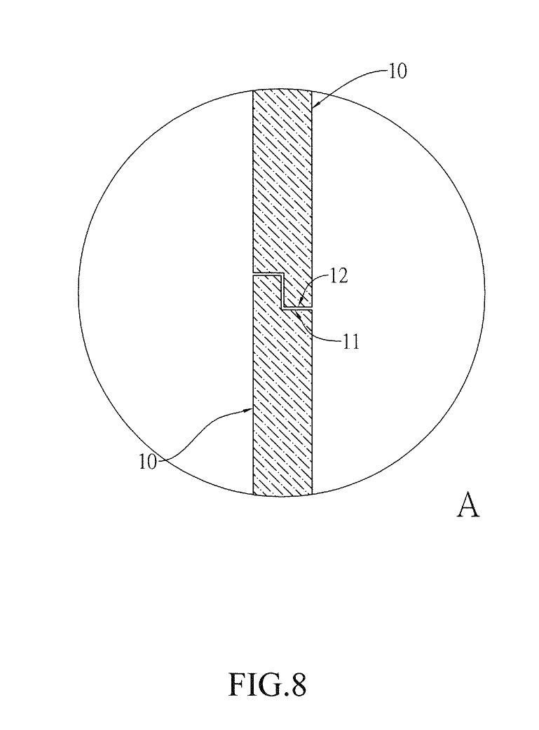

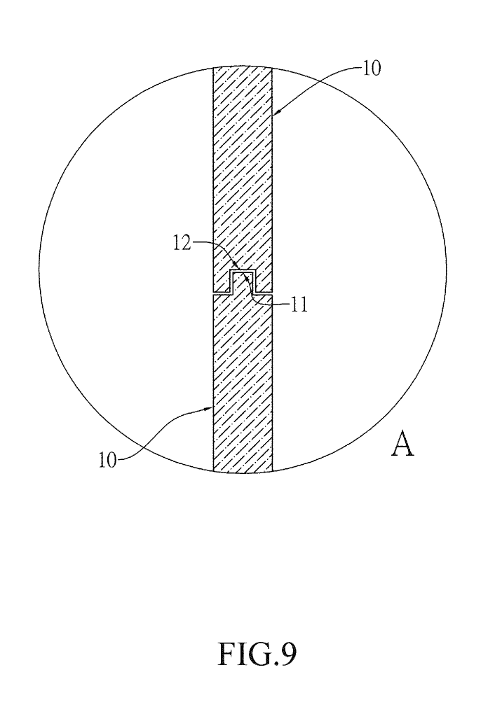

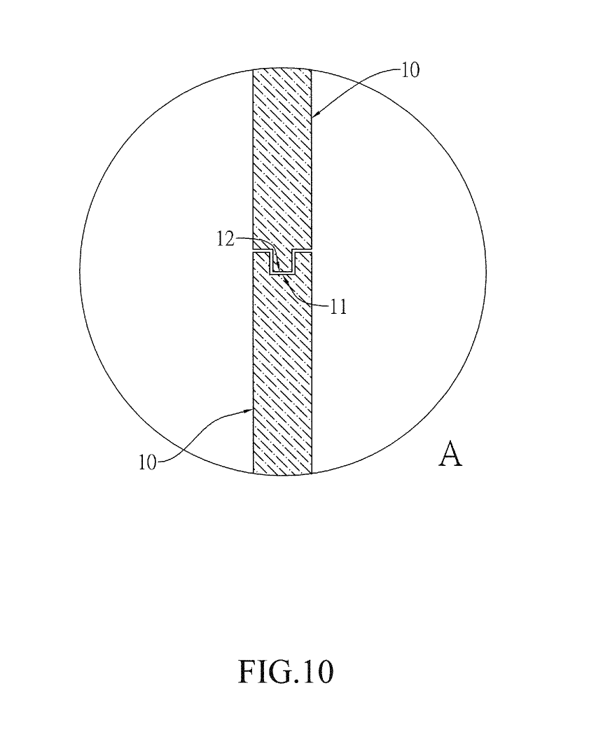

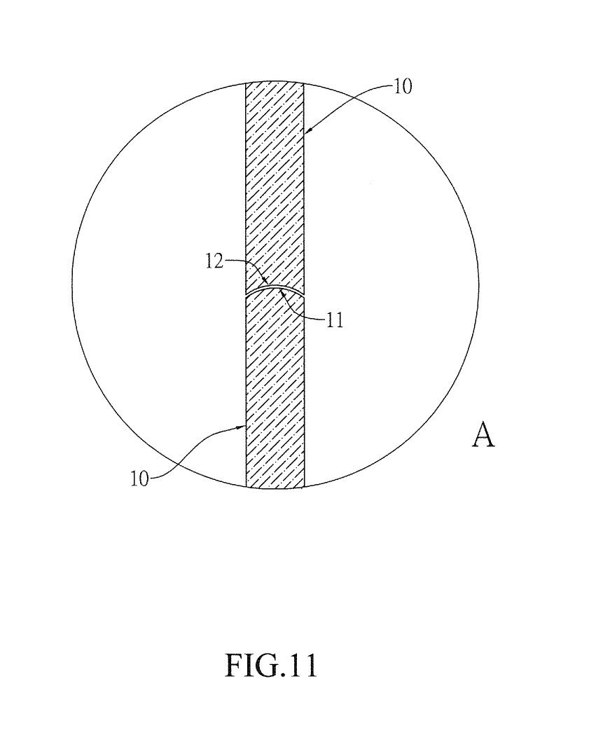

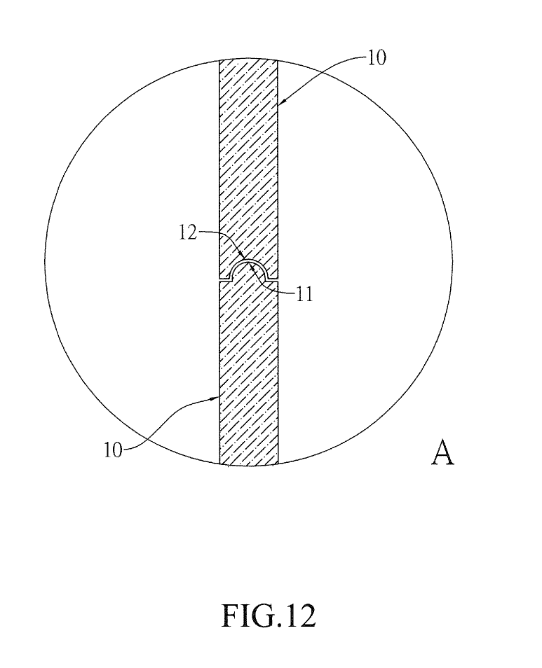

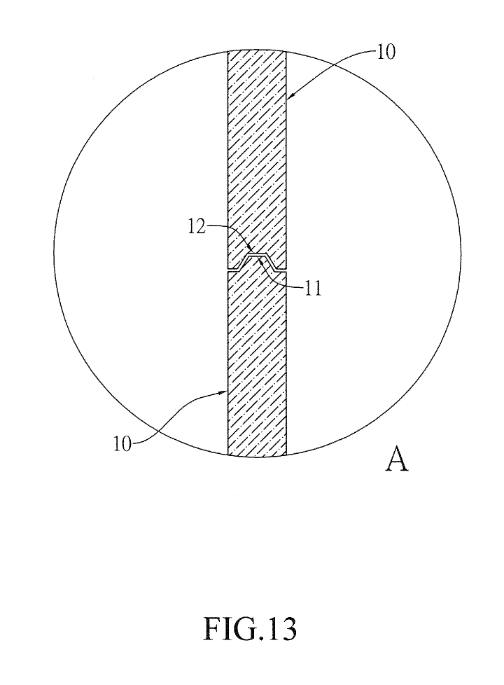

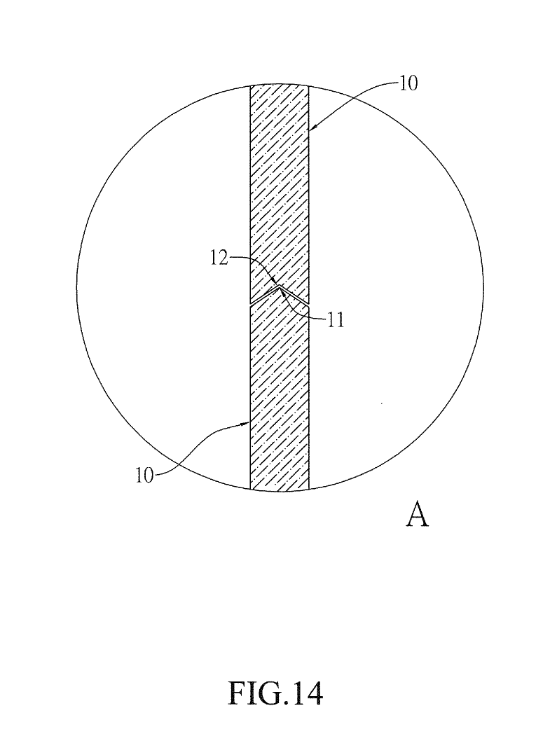

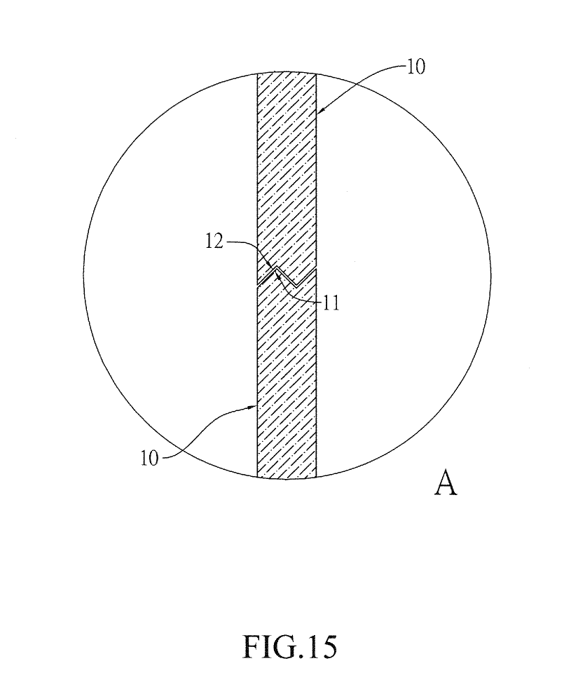

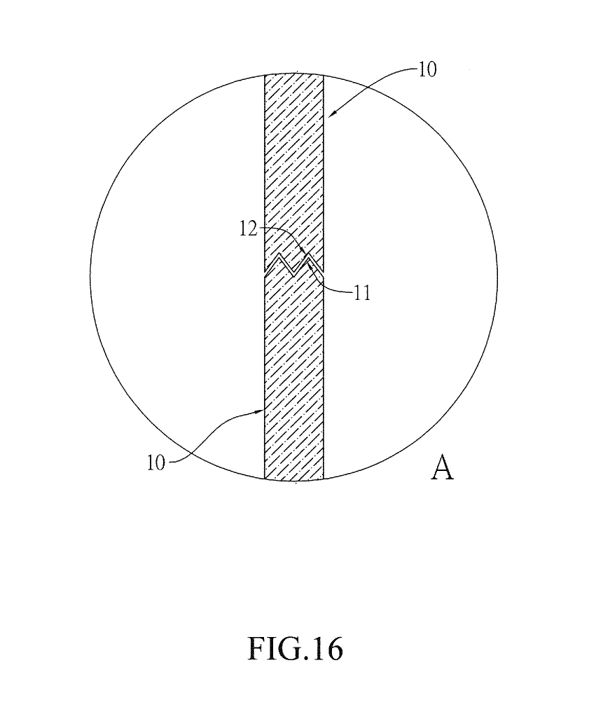

Also, otherwise, the upper coupling portion 11 may be a bump and the lower coupling portion 12 is a corresponding recess as FIGS. 6 to 16 show. Otherwise, the upper coupling portion 11 is a recess and the lower coupling portion 12 is a corresponding bump; no matter what it is, a bump or recess, the shape and type thereof are not limited; the bump is allowed to have an inclined face or curved face, and both can achieve a positioning effect as FIGS. 11 and 14 show.

Furthermore, the distance between the upper coupling portion 11 of each graphite short-tube 10 and the lower coupling portion 12 of another graphite short-tube 10 is smaller than 5 mm while being stacked together, thereby facilitating carrying out sintering.

Furthermore, pitch, tar, carbon glue, carbon paste, carbon and water (carbon mud), carbon dust, silicone, silicon paste, silicon water (mud) of silicon (Si), pozzolan or water may be added in between each two adjacent graphite short-tubes to be used as a consolation adhesive, capable of stabilizing the relative position of each two adjacent graphite short-tubes 10 temporarily before the sintering is carried out.

1. A combined graphite tube, combined by stacking a plurality of graphite short-tubes together, each said graphite short-tube comprising:
a upper coupling portion, positioned on a top face of a upper side of said graphite short-tube; and
a lower coupling portion, positioned on a bottom face of a lower side of said graphite short-tube, and corresponding to said upper coupling portion, allowing said upper coupling portion of each said graphite short-tube to be propped against said lower coupling portion of another graphite short-tube;
wherein said graphite short-tubes are fused and coupled together by means of a sintering treatment after said graphite short-tubes are stacked together.

2. The combined graphite tube according to claim 1, wherein said upper coupling portion is a flat plane and said lower coupling portion is a corresponding flat plane, or said coupling portion is an inclined plane inclined upward from outside to inside and said lower coupling portion is an inclined plane inclined upward from outside to inside, or, said upper coupling portion is an inclined plane inclined downward from outside to inside and said lower coupling portion is also an inclined plane inclined downward from outside to inside.

3. The combined graphite tube according to claim 1, wherein said upper coupling portion is a bump and said lower coupling portion is a corresponding recess, or, said upper coupling portion is a recess and said lower coupling portion is a corresponding bump.

4. The combined graphite tube according to claim 3, wherein said bump has an inclined or curved face.

5. The combined graphite tube according to claim 2, wherein a distance between said upper coupling portion of each said graphite short-tube and said lower coupling portion of another said graphite short-tube is smaller than 5 mm.

6. The combined graphite tube according to claim 4, wherein a distance between said upper coupling portion of each said graphite short-tube and said lower coupling portion of another said graphite short-tube is smaller than 5 mm.

7. The combined graphite tube according to claim 5, wherein pitch, tar, carbon glue, carbon paste, carbon and water (carbon mud), carbon dust, silicone, silicon paste, silicon water (mud) of silicon (Si), pozzolan or water is added in between each two said adjacent graphite short-tubes.

8. The combined graphite tube according to claim 6, wherein pitch, tar, carbon glue, carbon paste, carbon and water (carbon mud), carbon dust, silicone, silicon paste, silicon water (mud) of silicon (Si), pozzolan or water is added in between each two said adjacent graphite short-tubes.

9. A graphite crucible constituted by a combined graphite tube, comprising:
a combined graphite tube, combined by stacking a plurality of graphite short-tubes together, each said graphite short-tube comprising:
a upper coupling portion, positioned on a top face of a upper side of said graphite short-tube; and
a lower coupling portion, positioned on a bottom face of a lower side of said graphite short-tube, and corresponding to said upper coupling portion, allowing said upper coupling portion of each said graphite short-tube to be propped against said lower coupling portion of another said graphite short-tube; and
a graphite base, comprising a bottom coupling portion corresponding to said lower coupling portion, allowing said combined graphite tube to be stacked on said graphite base;
wherein said graphite short-tubes and said graphite base are fused and coupled together by means of a sintering treatment after said graphite short-tubes and said graphite base are stacked together.

10. The graphite crucible according to claim 9, wherein said upper coupling portion is a flat plane and said lower coupling portion is a corresponding flat plane, or said coupling portion is an inclined plane inclined upward from outside to inside and said lower coupling portion is an inclined plane inclined upward from outside to inside, or, said upper coupling portion is an inclined plane inclined downward from outside to inside and said lower coupling portion is also an inclined plane inclined downward from outside to inside.

11. The graphite crucible according to claim 9, wherein said upper coupling portion is a bump and said lower coupling portion is a corresponding recess, or, said upper coupling portion is a recess and said lower coupling portion is a corresponding bump.

12. The graphite crucible according to claim 11, wherein said bump has an inclined or curved face.

13. The graphite crucible according to claim 10, wherein a distance between said upper coupling portion of each said graphite short-tube and said lower coupling portion of another said graphite short-tube is smaller than 5 mm.

14. The graphite crucible according to claim 12, wherein a distance between said upper coupling portion of each said graphite short-tube and said lower coupling portion of another said graphite short-tube is smaller than 5 mm.

15. The graphite crucible according to claim 13, wherein pitch, tar, carbon glue, carbon paste, carbon and water (carbon mud), carbon dust, silicone, silicon paste, silicon water (mud) of silicon (Si), pozzolan or water is added in between each two said adjacent graphite short-tubes.

16. The graphite crucible according to claim 14, wherein pitch, tar, carbon glue, carbon paste, carbon and water (carbon mud), carbon dust, silicone, silicon paste, silicon water (mud) of silicon (Si), pozzolan or water is added in between each two said adjacent graphite short-tubes.
